(19) United States
(12) Patent Application Publication
(10) Pub. No.: US 2010/0157587 A1
(43) Pub. Date: Jun. 24, 2010

(54) LIGHT-EMITTING UNIT AND ELECTRONIC DEVICE USING THE SAME

(76) Inventor: Hiroto ISODA, Fujiyoshida-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/645,034

(22) Filed: Dec. 22, 2009

(30) Foreign Application Priority Data
Dec. 23, 2008 (JP) JP2008-326645

(51) Int. Cl. F21V 9/00; F21V 1/00; F21V 17/00

(52) U.S. Cl. 362/231; 362/235; 362/375

(57) ABSTRACT

A light-emitting unit having a plurality of LED light sources (7a to 7d) and a planar lightguide (2) that guides light from the LED light sources (7a to 7d) and that emits the light from a light-exiting portion located on an outer periphery (2a). The planar lightguide (2) has a reflecting portion (2b) that reflects light from the LED light sources to emit the light to the outside from the light-exiting portion of the outer periphery (2a). The planar lightguide (2) also guides light from the LED light sources directly to the outer periphery (2a) to emit the light to the outside from the light-exiting portion.

This application claims priority under 35 U.S.C. Section 119 to Japanese Patent Application No. 2008-326645 filed on Dec. 23, 2008, the entire content of which is hereby incorporated by reference.

### BACKGROUND OF THE INVENTION

1. Field of the Invention

The present invention relates to a light-emitting unit and to electronic devices having a visual effect of the illumination such as mobile phones, for example. More particularly, the present invention relates to a light-emitting unit that emits light along the outer peripheral edge of a casing of an electronic device, and also relates to an electronic device using such a light-emitting unit.

2. Description of the Related Arts

Many mobile phones and other electronic devices have a foldable casing. Among such mobile phones are those which have not only a main liquid crystal display provided on the inner side of the casing but also a simple illumination mechanism, e.g. a light-emitting diode (LED) light source, a liquid crystal display panel, or an organic electroluminescence (EL) panel, provided on the outer side of the casing to alert the user to an incoming call or message and to improve the design quality and so forth.

To emit light along the outer peripheral edge of a mobile electronic device as stated above, use may be made of a technique such as that disclosed in Japanese Patent Application Publication No. 2001-318235, for example. According to this technique, a lightguide tube is provided to extend along the peripheral edge of a liquid crystal display panel. The lightguide tube guides light received from one end and allows the light to enter the liquid crystal display panel inwardly from the side surface of the lightguide tube through the peripheral edge surface of the liquid crystal display panel that is adjacent to the inner side of the lightguide tube, thus illuminating the front surface of the liquid crystal display panel. Accordingly, it is possible to emit light along the outer peripheral edge of a mobile electronic device, as stated above, by directing light passing through the lightguide tube to emit in a direction other than inward. However, the lightguide tube has a cylindrical shape and therefore requires a wide accommodating space in the casing of the mobile electronic device. In addition, the lightguide tube is difficult to bend at an intermediate portion and hence needs a reflecting structure, e.g. a mirror, at each corner, which leads undesirably to increases in component cost and installation space. It is also difficult for the lightguide tube to cope with various configurations and illumination patterns. Further, because a light source is disposed at one end of the lightguide tube, it is impossible to emit light outwardly in the vicinity of the light source and hence impossible to emit light over the entire circumferential length of the lightguide tube. Accordingly, a ring-shaped illumination cannot be performed.

### SUMMARY OF THE INVENTION

The present invention has been made in view of the above-described circumstances. Accordingly, an object of the present invention is to provide a light-emitting unit of space saving and various illumination patterns. Another object of the present invention is to provide an electronic device using the light-emitting unit of the present invention.

The present invention provides a light-emitting unit including a planar lightguide having a light-transmitting portion, a reflecting portion provided in the planar lightguide, and a light-exiting portion provided on an outer periphery of the planar lightguide; a plurality of light-emitting diode light sources disposed in the light-transmitting portion of the planar lightguide to emit light into the planar lightguide; and the reflecting portion that receives light emitted from the light-emitting diode light sources and reflects light toward the outer periphery of the planar lightguide, the light-exiting portion on the outer periphery of the planar lightguide to emit light to an outside of the planar lightguide.

In the light-emitting unit of the present invention, light from the light-emitting diode light sources is emitted from the outer periphery of the planar lightguide.

Specifically, the reflecting portion may be an opening. The opening may be a pass-through hole that extends from a front surface to a rear surface of the planar lightguide. There is an interface between the light-transmitting portion and the reflecting portion, and the interface reflects light from the light-emitting diode light sources effectively. The reflecting portion has a smaller refractive index than that of the light-transmitting portion to totally reflect light on the interface.

The opening may have an elongated shape, and the light-emitting diode light sources are disposed along elongated opposite sides of the opening.

This arrangement is convenient when the light-emitting unit emits light from the entire outer periphery of the planar lightguide.

The light-emitting diode light sources are preferably provided in the light-transmitting portion of the planar lightguide, and light-emitting surfaces of the light-emitting diode light sources obliquely face the elongated sides of the opening. The light-transmitting portion may include a plurality of holes each accommodating each of the light-emitting diode light sources.

The light-emitting diode light sources may be installed at the outer periphery of the planar lightguide. In this regard, however, dark spots where no light is emitted can be eliminated from the outer periphery of the planar lightguide by providing the light-emitting diode light sources within the planar lightguide.

The light-emitting diode light sources may include a first pair of light-emitting diode light sources disposed along a first elongated side of the elongated opposite sides, and a second pair of light-emitting diode light sources disposed along a second elongated side of the elongated opposite sides of the opening.

The planar lightguide can be divided into a first and a second light-transmitting areas by the elongated opening, and the respective outer peripheral portions of the first and second light-transmitting areas of the planar lightguide can emit light independently from each other. Respective optical axes of the first pair of light-emitting diode light sources may obliquely intersect each other, and respective optical axes of the second pair of light-emitting diode light sources may obliquely intersect each other.

With this arrangement, the light-emitting unit can emit, from the outer periphery of the planar lightguide, light from each light-emitting diode light source in each pair and color-mixed light from the light-emitting diode light sources of each pair.

The opening may have a polygonal shape. That is, the opening may assume various configurations in accordance with the desired color mixing of light to be emitted from the outer periphery of the planar lightguide.

The light-emitting diode light sources may have a red light-emitting diode element, a green light-emitting diode element, and a blue light-emitting diode element. It is possible to emit various colors of light by mixing together the colors of light from these light-emitting diode elements.

The planar lightguide may be made of a light-transmitting film. A light-transmitting film can be easily cut into various shapes and can be curved and bent freely. Accordingly, it is possible to present light emission in even more various patterns.

The planar lightguide further has a microscopic optical configuration portion formed along the outer periphery of the planar lightguide, and the microscopic optical configuration portion deflects light that is transmitted through the light-transmitting portion of the planar lightguide.

When such a microscopic optical configuration portion is omitted, the planar lightguide emits light from the peripheral edge surface of the outer periphery as the light-exiting portion. The microscopic optical configuration portion provided as stated above deflects the transmitted light to exit from a front surface of the planar lightguide.

The planar lightguide may have a pair of outer layers and an inner layer sandwiched between the outer layers, and the inner layer has a larger refractive index than that of the outer layers. This structure increases the efficiency of guiding light entering the planar lightguide.

In addition, the present invention provides an electronic device including a casing and a light-emitting unit arranged as stated above, which is installed in the casing. The casing having a light-exiting portion disposed adjacent to the outer periphery of the planar lightguide to exit light that is emitted from the planar lightguide to an outside of the casing.

The electronic device may be a mobile phone, and the light-emitting diode light sources of the light-emitting unit are driven according to the condition of a communication function.

Embodiments of the light-emitting unit according to the present invention will be explained below with reference to the accompanying drawings. In the figures used in the following explanation, the scale is properly changed to show each constituent member in a recognizable size.

### BRIEF DESCRIPTION OF THE DRAWINGS

FIG. 1 is a schematic view of a light-emitting unit according to a first embodiment of the present invention, showing light propagation directions in the light-emitting unit.

FIG. 2 is an exploded perspective view of the light-emitting unit shown in FIG. 1.

FIG. 3 is a plan view of a mobile phone (electronic device) incorporating the light-emitting unit shown in FIG. 1.

FIG. 4 is a perspective view showing the light-emitting unit in FIG. 1 as installed on a support plate portion of a casing of the mobile phone.

FIG. 5 is a perspective view showing the light-emitting unit in FIG. 1 as installed on the support plate portion of the casing of the mobile phone, with a light-blocking member mounted over a surface at the light-transmitting portion and the light-reflecting portion of the planar lightguide.

FIG. 6 is a plan view of the light-emitting unit in FIG. 1, showing light-emitting regions of the light-emitting unit.

FIG. 7 is a schematic view of a light-emitting unit according to a second embodiment of the present invention, showing light emission directions from the light-emitting unit.

FIG. 8 is a perspective view of a mobile phone (electronic device) incorporating the light-emitting unit shown in FIG. 7.

FIG. 9 is a fragmentary enlarged sectional view of a modification of a planar lightguide used in the light-emitting unit shown in FIG. 7.

FIG. 10 is a perspective view of a light-emitting unit according to a third embodiment of the present invention.

### DESCRIPTION OF THE PREFERRED EMBODIMENTS

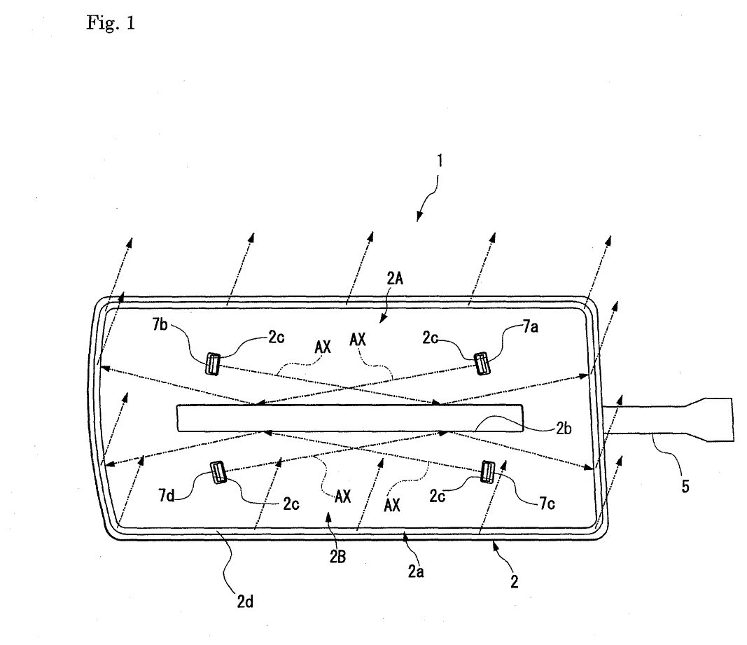

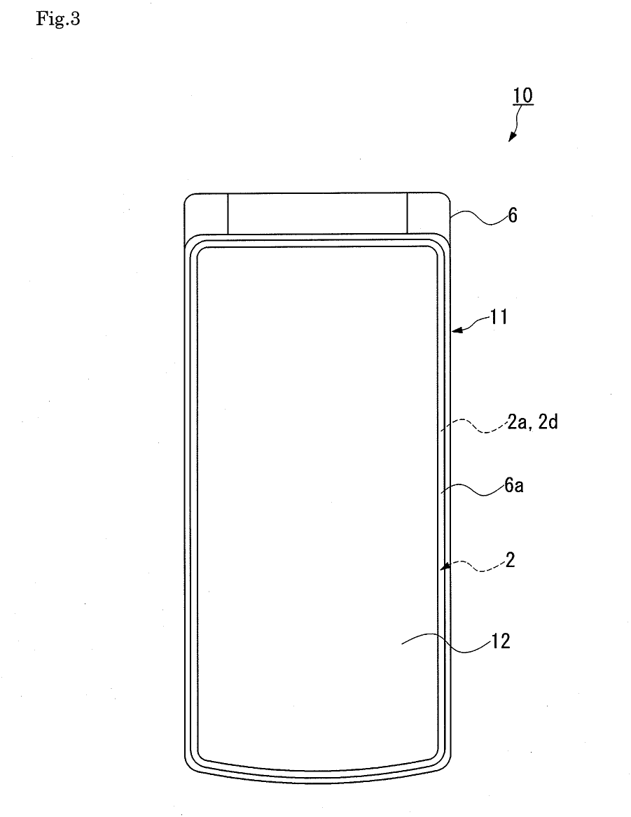

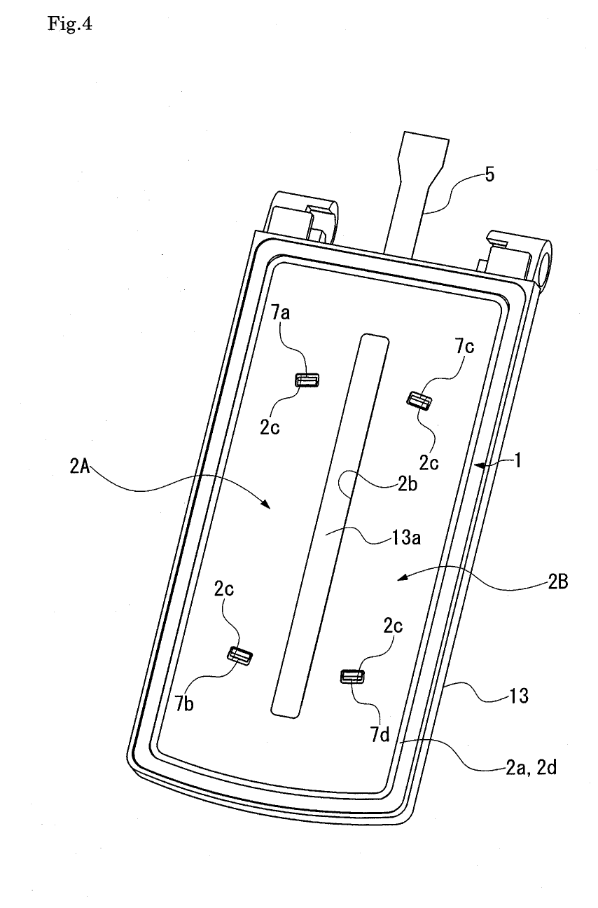

As shown in FIGS. 1 to 6, a light-emitting unit 1 according to a first embodiment of the present invention is installed in a casing of an electronic device to emit light along an outer peripheral portion of the casing. The casing 6 constituting a pivotable cover of a foldable mobile phone 10, for example, to emit light in a rectangular ring shape along the outer peripheral edge of the front surface of the casing 6.

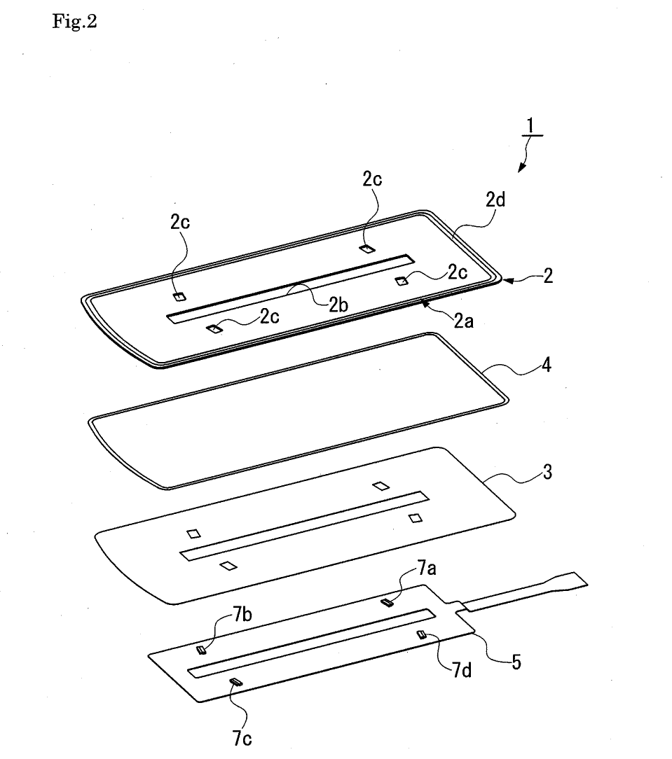

The light-emitting unit 1 has, as shown particularly in FIG. 2, a planar lightguide 2 having a light-transmitting portion, a reflecting portion 26 provided in the planar lightguide, and a light-exiting portion provided on an outer periphery 2a of the planar lightguide, a plurality of LED light sources 7a, 7b, 7c, and 7d disposed in the light-transmitting portion of the planar lightguide to emit light into the planar lightguide. A reflecting sheet 3 installed at the rear side of the planar lightguide 2, an annular piece of double-coated adhesive tape 4 provided along the peripheral edge of the reflecting sheet 3 to bond the planar lightguide 2 and the reflecting sheet 3 to each other, and a flexible printed circuit board 5 installed at the rear side of the reflecting sheet 3 and the LED light sources 7a, 7b, 7c, and 7d are provided on the flexible printed circuit board.

The planar lightguide 2 is formed by cutting, for example, an acrylic, polycarbonate or silicone resin film having light-transmitting properties into a desired shape, e.g. a substantially rectangular shape as shown in the figures. The planar lightguide 2 may be molded from a resin material. The front and rear surfaces of the planar lightguide 2 are mirror-finished to improve the properties of reflecting light inward.

The center of the planar lightguide 2 is provided with an opening having an elongated shape or slit 2b as a reflecting portion extending in the longitudinal direction of the planar lightguide 2. The elongated opening 2b including elongated opposite sides divides the planar lightguide 2 into two light-transmitting areas 2A and 2B. The light-transmitting portion of the lightguide have a pair of pass-through holes 2c disposed at each of the light-transmitting areas 2A and 2B, each pair of pass-through holes spaced from each other in the longitudinal direction of the elongated opening 2b. The LED light sources 7a, 7b, 7c and 7d are provided in the pass-through holes 2c, respectively. The light-emitting surfaces of the LED light sources 7a to 7d are adjacently disposed at the respective wall surfaces of the pass-through holes 2c to emit light into the planar lightguide 2.

The light-emitting surfaces of a first pair of LED light sources 7a and 7b obliquely face a first elongated side of the elongated opposite sides, and the light-emitting surfaces of a second pair of LED light sources 7c and 7d obliquely face a second elongated side of the elongated opposite sides.

The first pair of LED light sources 7a and 7b provided in the light-transmitting portion at a first elongated light-transmitting area 2A are disposed with the respective optical axes AX obliquely intersecting each other, and the second pair of LED light sources 7c and 7d provided in the light-transmitting portion at a second elongated light-transmitting area 2B as shown FIG. 1. In the illustrated example, each pair of LED light sources are disposed on an imaginary line parallel to the longitudinal direction of the elongated opening2b in each of the first and second elongated light-transmitting area 2A and 2B. The pass-through holes 2c are each formed in a rectangular shape in accordance with the outer shape and orientation of the light-emitting surfaces of the LED light sources 7a to 7d installed in the pass-through holes 2c.

An rectangular ring-shaped microscopic optical configuration portion 2d is provided on the front surface of the planar lightguide 2 along the outer periphery 2a of the planar lightguide. The microscopic optical configuration portion 2d deflects light that is emitted from the LED light sources 7a to 7d and transmitted through the light-transmitting portion of the planar lightguide 2 to reach the microscopic optical configuration portion 2d. That is, the microscopic optical configuration portion 2d directs the transmitted light in the planar lightguide to exit to the outside of the planar lightguide 2. Although in the illustrated example the microscopic optical configuration portion 2d is provided on the front surface of the planar lightguide 2, from which the planar lightguide 2 emits light, the microscopic optical configuration portion 2d may be formed on the rear surface of the planar lightguide 2 in a rectangular ring shape to direct the light to exit from the front surface of the planar lightguide 2 upward in a rectangular ring shape along the peripheral edge of the casing. The microscopic optical configuration portion 2d may comprise a plurality of convex dots formed on the front or rear surface of the planar lightguide 2 by laser processing or printing white ink. Alternatively, the microscopic optical configuration portion 2d may comprise a plurality of microscopic grooves formed by laser processing. The casing 6 has a light-exiting portion 6 adisposed adjacent to the outer periphery of the planar lightguide to exit light that is emitted from the planar lightguide to an outside of the casing. The microscopic optical configuration portion 2d of the planar lightguide 2 is disposed at the rear side of and close to the light-exiting portion 6a. The light-exiting portion 6a transmits the light, which is directed to exit from the planar lightguide 2 by the microscopic optical configuration portion 2d, to the outside of the casing 6.

The LED light sources 7a to 7d in this embodiment each comprise an RGB-LED having a red LED element, a green LED element and a blue LED element. The flexible printed circuit board 5 has circuit patterns that are electrically connected to the LED light sources 7a to 7d.

The reflecting sheet 3 may be a metal sheet, film, foil or the like having a light-reflecting function, e.g. a film provided with an evaporated silver layer or a film provided with an evaporated aluminum layer. In this embodiment, a white sheet is used as the reflecting sheet 3. The reflecting sheet 3 has been cut out at regions directly below the elongated opening 2b and the pass-through holes 2c.

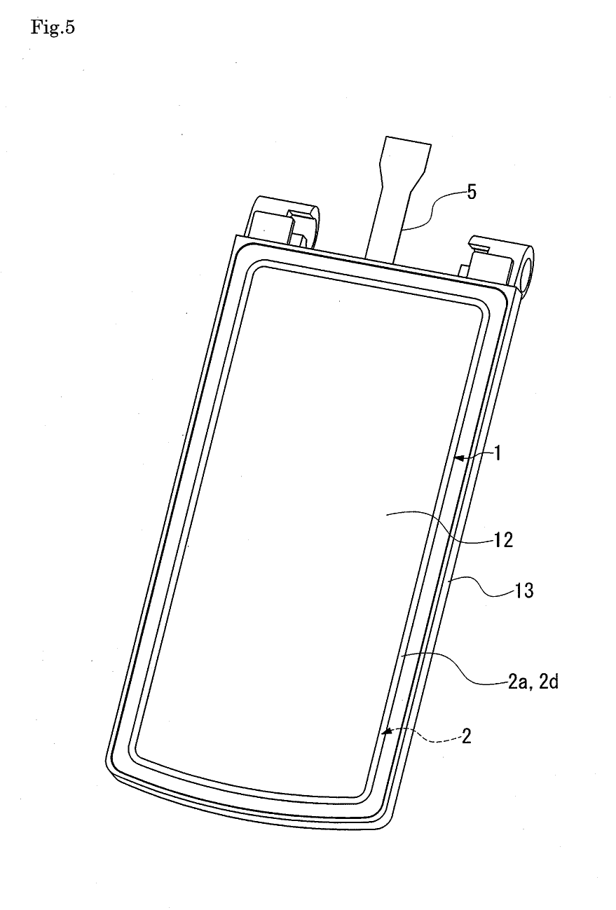

The casing 6 has a support plate portion 13 disposed at the lower side of the light-emitting unit 1 to support the unit 1. A light-blocking member 12 made of an opaque material and provided inside the ring-shaped light-exiting portion 6a covers the light-transmitting portion, the LED light sources 7a to 7d and the elongated opening 2b from above. By covering the LED light sources 7a to 7d and the elongated opening 2b, which are provided inside the casing 6, the light-blocking member 12 conceals the light sources 7a to 7d and the elongated opening 2b from the outside. The light-blocking member 12 may be formed together with the casing 6 as one unit. The light-blocking member 12 may also be provided over the top of the planar lightguide 2 inside the outer periphery 2a of the planar lightguide 2, as shown in FIG. 5. The support plate portion 13 has a rectangular projection 13a that is fitted into the elongated opening 2b. Fitting the elongated opening 2b with the projection 13a further improves the light-blocking effect between the light-transmitting areas 2A and 2B at the elongated opening 2b. If the projection 13a is formed by using a white resin, the projection 13a reflects leaking light, resulting in an improvement in the lightguide performance. Thus, the luminance increases.

The mobile phone 10 enables the light-emitting unit 1 to be controlled by a control unit (not shown) according to the condition of a communication function. That is, the light emission of each of the LED light sources 7a to 7d is controlled at the time, for example, of sending and receiving calls and e-mails. Thus, the light-emitting unit 1 emits light from the outer periphery 2a of the planar lightguide 2 in a preset flashing mode and in a preset light emission color and let the light exit to the outside through the light-exiting portion 6a of the casing 6.

In the light-emitting unit 1 of this embodiment, the first pair of LED light sources 7a and 7b disposed in the first light-transmitting area 2A and the second pair of LED light sources 7c and 7d in the second light-transmitting area 2B emit light toward the elongated opening 2b or directly to the outer periphery 2a. The longitudinal wall surfaces defining the elongated opening 2b totally reflect the light from the LED light sources 7a to 7d toward the outer periphery 2a. Thus, the planar lightguide 2 guides the light to the outer periphery 2a and emits the light in a ring shape as a whole from the outer periphery 2a through the microscopic optical configuration portion 2d.

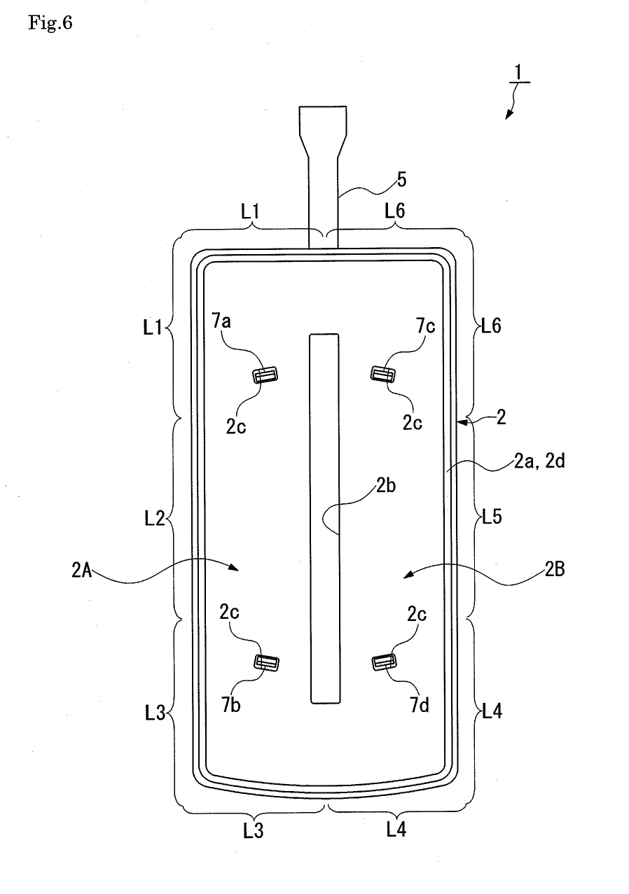

The amount and color of light emitted from the outer periphery 2a can be varied in a variety of ways by controlling at least either of the light quantity or the light emission color for each of the LED light sources 7a to 7d in the light-transmitting areas 2A and 2B. That is, as shown in FIG. 6, the amount and color of light emitted from the outer periphery 2a can be varied among the following regions of the light-transmitting areas 2A and 2B: two regions L1 and L3 of the outer periphery 2a behind the LED light sources 7a and 7b in the light-transmitting area 2A; one region L2 of the outer periphery 2a between the LED light sources 7a and 7b; two regions L6 and L4 of the outer periphery 2a behind the LED light sources 7c and 7d in the light-transmitting area 2B; and one region L5 of the outer periphery 2a between the LED light sources 7c and 7d. More specifically, the regions L2 and L5 emit, as color-mixed light, light from the mutually opposing LED light sources 7a and 7b and light from the mutually opposing LED light sources 7c and 7d, respectively. The regions L1, L3, L4 and L6 emit only light from the LED light sources 7b, 7a, 7c and 7d, which the regions L1, L3, L4 and L6 face, respectively.

For example, if the LED light sources 7a and 7d emit green light and the LED light sources 7b and 7c emit blue light and red light, respectively, as shown in FIG. 6, it is possible to emit various colors of light to the outside from the light-emitting regions L1 to L6 of the outer periphery 2a: blue light from the light-emitting region L1; blue-green mixed light from the light-emitting region L2; green light from the light-emitting region L3; red light from the light-emitting region L4; red-green mixed light from the light-emitting region L5; and green light from the light-emitting region L6. Thus, two sets of three light-emitting regions that emit light in different ways can be obtained for the light-transmitting areas 2A and 2B, respectively, and six light-emitting regions L1 and L6 can be obtained along the ring-shaped outer periphery 2a.

The respective outer peripheral portions 2a of the light-transmitting areas 2A and 2B can emit light substantially independently of each other. For this purpose, the elongated opening 2b preferably has a length sufficient for the elongated opening 2b to extend beyond at least the light-emitting surfaces of the LED light sources 7a to 7d. The two pairs of LED light sources are disposed in the light-transmitting areas 2A and 2B, respectively, divided by the elongated opening 2b. Each pair of LED light sources are disposed on an imaginary line parallel to the longitudinal direction of the elongated opening 2b, with the respective optical axes obliquely intersecting the associated side wall of the elongated opening 2b. In this regard, reducing the length of the elongated opening 2b produces regions where light from the light-transmitting areas 2A and 2B mix together. Thus, the range of color-mixing regions can be adjusted by controlling the length of the elongated opening 2b. If one of the LED light sources 7a to 7d is selected to be turned on, one-fourth of the outer periphery 2a can be selectively lit up. Because of being made of a pliable lightguide film, the planar lightguide 2 can be readily formed by cutting the film and can be curved and bent freely. Accordingly, it is possible to present illumination light in even more various patterns.

With the mobile phone 10, the light-emitting unit 1 can be controlled according to the condition of the communication function. Therefore, the outer periphery of the front surface of the casing 6 can be lit up in a ring shape according to the condition of the communication function at the time, for example, of sending and receiving calls and e-mails. Such an illumination effect provides high visibility to recognize communication conditions and so forth.

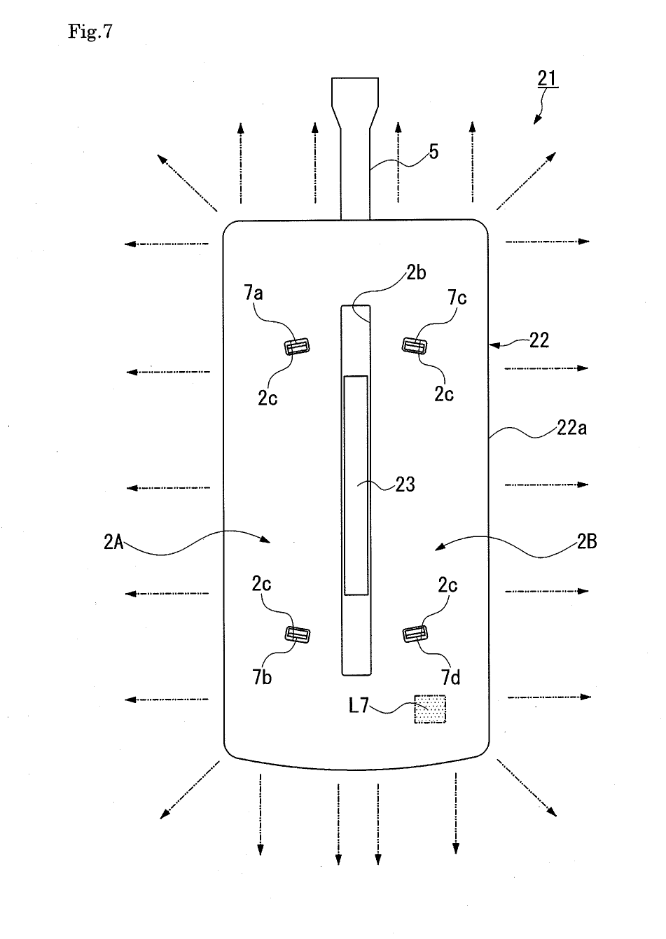

Other embodiments of the present invention will be explained below with reference to FIGS. 7 to 10. In the following explanation of each embodiment, the same constituent elements as those explained in the foregoing first embodiment are denoted by the same reference numerals as used in the first embodiment, and a description of the same constituent elements is omitted.

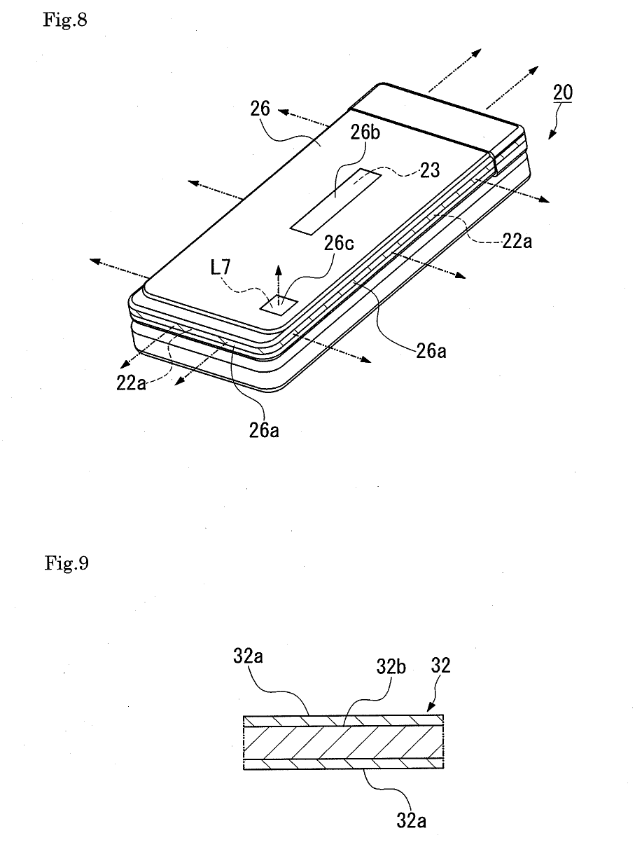

FIGS. 7 and 8 show a light-emitting unit 21 according to a second embodiment of the present invention. The light-emitting unit 21 has no microscopic optical configuration portion 2d on the outer periphery 22a of a planar lightguide 22 and hence emits the guided light sideward from the outer peripheral end surface of the outer periphery 22a.

A mobile phone 20 shown in FIG. 8 has a linear or band-shaped light-exiting portion 26a annularly provided on the outer peripheral side surface of a casing 26. The light-exiting portion 26a may be a transparent portion or translucent portion. The outer peripheral end surface of the outer periphery 22a of the planar lightguide 22 is disposed close to the inner side of the light-exiting portion 26a.

In the second embodiment, a local light-emitting region L7 is formed on a part of the front or rear surface of the planar lightguide 22. The local light-emitting region L7 is provided with a microscopic optical configuration that deflects light that is guided through the planar lightguide 22 to emit the light from the front side of the lightguide 22. The microscopic optical configuration of the local light-emitting region L7 may comprise a plurality of convex dots formed on the front or rear surface of the planar lightguide 22 by laser processing or printing white ink. Alternatively, the microscopic optical configuration may comprise a plurality of grooves formed by laser processing.

Further, in the second embodiment, a liquid crystal display panel 23 capable of displaying information is fitted in the elongated opening 2b as a rear sub-panel of the mobile phone 20. The light-blocking member 12 of the casing 26 has windows 26b and 26c provided in respective regions directly above the liquid crystal display panel 23 and the local light-emitting region L7. The windows 26b and 26c are formed by using a light-transmitting material. That is, the user can see the display on the liquid crystal display panel 23 through the window 26b, and the local light-emitting region L7 emits light to the outside through the window 26c.

The liquid crystal display panel 23 is a transmissive or semitransmissive liquid crystal display panel. In the case of a transmissive type, for example, the liquid crystal display panel 23 has a TFT, STN, TN or other liquid crystal panel body having a liquid crystal material sealed with a sealant in a gap between an upper substrate and a lower substrate, each having a transparent electrode layer, an alignment film and a polarizer.

Thus, in the second embodiment, the light-emitting unit 21 emits guided light from the outer peripheral end surface of the planar lightguide 22. Therefore, it is possible to emit elongated, linear light beams in a ring shape from the outer peripheral side surface of the casing 26 at a high luminance.

Because the liquid crystal display panel 23 is installed in the elongated opening 2b, it is possible to prevent the planar lightguide 22 and the liquid crystal display panel 23 from overlying each other, which would otherwise result in an increase in the overall thickness. In addition, the local light-emitting region L7 emits light toward the front side of the planar lightguide 22. In other words, the local light-emitting region L7 emits light from the rear side of the casing 26. Therefore, it is possible to obtain a local one-point illumination effect on the rear side of the mobile phone 20 in addition to the illumination effect along the outer periphery 22a.

FIG. 9 is a fragmentary sectional view showing a planar lightguide 32 as a modification of the planar lightguide 22. The planar lightguide 32 is formed from a lightguide film comprising three layers: two opposite outer layers 32a and an inner layer 32b made of a material having a higher refractive index than that of the outer layers 32a. The planar lightguide 32 having such a three-layer structure can exhibit enhanced light-guiding efficiency and provide an increased luminance at the outer periphery of the planar lightguide 32. Each of the outer and inner layers 32a and 32b may comprise a plurality of layers.

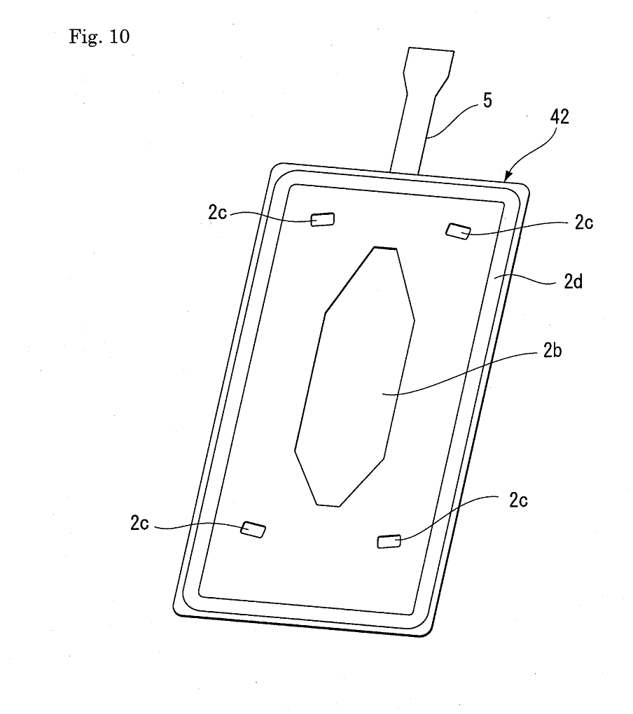

FIG. 10 shows a planar lightguide 42 according to a third embodiment of the present invention. In the third embodiment, the reflecting portion 2b provided in the center of the planar lightguide 42 is of elongated octagonal configuration extending in the longitudinal direction of the planar lightguide 42. The reflecting portion 2b may be formed as an opening as in the case of the foregoing embodiments. The opening serving as the reflecting portion 2b may be filled with a resin material having a lower refractive index than that of the planar lightguide 42 or a white or other material having a high reflectivity. With this structure, color mixing of light from the LED light sources can be made more complicated than in the foregoing embodiments. FIG. 10 shows merely one modification of the reflecting portion 2b. The reflecting portion 2b may be modified variously to adjust the color mixing of light to be emitted from the outer periphery 2a of the planar lightguide 42.

It should be noted that the present invention is not limited to the foregoing embodiments but can be modified in a variety of ways without departing from the scope of the present invention.

For example, in the foregoing embodiments, the LED light sources are provided within the planar lightguide. The LED light sources, however, may be installed at the outer periphery of the planar lightguide to emit light toward the reflecting portion.

Although in the foregoing embodiments the light-emitting unit of the present invention is provided in a foldable mobile phone, the light-emitting unit may be installed in other types of mobile phones. For example, the light-emitting unit of the present invention may be installed in candy-bar type (straight) mobile phones or slide-type mobile phones.

Although in the foregoing embodiments the light-emitting unit of the present invention is installed in a mobile phone, the light-emitting unit may be used in other electronic devices such as personal digital assistants (PDAs), notebook personal computers (PCs), electronic dictionaries, digital cameras, and mobile music players. Further, the light-emitting unit of the present invention may be installed in wall-mounting displays or signboards.

In the foregoing embodiments, the planar lightguide is made of a relatively soft and thin acrylic or silicone resin sheet. Therefore, the planar lightguide is installed in the casing with the outer periphery of the lightguide being close to the light-transmitting portion provided on the surface of the casing. If a rigid polycarbonate or acrylic resin is used to form the planar lightguide, the outer periphery of the planar lightguide may be exposed and lit up directly on the surface of the casing.

Further, in the foregoing embodiments, LED light sources comprising RGB-LEDs are used to emit various colors of illumination light. In the case of merely emitting monochromatic illumination light through the light quantity adjustment, however, monochromatic LEDs, e.g. white LEDs, may be used. Although in the foregoing embodiments a slit, i.e. an elongated rectangular hole, is formed in the planar lightguide, the slit configuration may be changed, for example, by forming prisms or the like on the inner surfaces of the slit, or adjusting the extending direction of the inner surfaces, to adjust the reflection of light from the LED light sources. Although in the foregoing embodiments four LED light sources are divided into two sets by one slit, three or more pairs of LED light sources may be divided into three or more sets by a plurality of slits.

It should be noted that the present invention is not necessarily limited to the foregoing embodiment but can be modified in a variety of ways without departing from the gist of the present invention.

1. A light-emitting unit comprising:
a planar lightguide having a light-transmitting portion, a reflecting portion provided in the planar lightguide, and a light-exiting portion provided on an outer periphery of the planar lightguide;
a plurality of light-emitting diode light sources disposed in the light-transmitting portion of the planar lightguide to emit light into the planar lightguide; and the light-transmitting portion of the planar lightguide that transmits light emitted from the light-emitting diode light sources,
the reflecting portion in the planar lightguide that receives light emitted from the light-emitting diode light sources and reflects light toward the outer periphery of the planar lightguide;
the light-exiting portion on the outer periphery of the planar lightguide to emit light to an outside of the planar lightguide.

2. The light-emitting unit of claim 1, the planar light guide further having an interface between the light-transmitting portion and the reflecting portion, the reflecting portion having a smaller refractive index than that of the light-transmitting portion to totally reflect light on the interface.

3. The light-emitting unit of claim 2, wherein the reflecting portion is an opening.

4. The light-emitting unit of claim 3, wherein the opening is a pass-through hole that extends from a front surface to a rear surface of the planar lightguide.

5. The light-emitting unit of claim 1, wherein the reflecting portion comprises a resin material of light reflectivity.

6. The light-emitting unit of claim 3, wherein the opening has an elongated shape, and the light-emitting diode light sources are disposed along elongated opposite sides of the opening.

7. The light-emitting unit of claim 6, wherein light-emitting surfaces of the light-emitting diode light sources obliquely face the elongated sides of the opening.

8. The light-emitting unit of claim 7, wherein the light-emitting diode light sources comprises a first pair of light-emitting diode light sources disposed along a first elongated side of the elongated opposite sides, and a second pair of light-emitting diode light sources disposed along a second elongated side of the elongated opposite sides of the opening.

9. The light-emitting unit of claim 3, wherein the opening has a polygonal shape.

10. The light-emitting unit of claim 1, wherein the light-emitting diode light sources comprise a red light-emitting diode element, a green light-emitting diode element, and a blue light-emitting diode element.

11. The light-emitting unit of claim 1, wherein the planar lightguide is a light-transmitting film.

12. The light-emitting unit of claim 1, the planar lightguide further having a microscopic optical configuration portion formed along the outer periphery of the planar lightguide, the microscopic optical configuration portion deflecting light that is transmitted through the light-transmitting portion of the planar lightguide.

13. The light-emitting unit of claim 1, wherein the planar lightguide comprises a pair of outer layers and an inner layer sandwiched between the outer layers, and the inner layer has a larger refractive index than that of the outer layers.

14. An electronic device comprising:
a casing; and
the light-emitting unit of claim 1, which is installed in the casing;
the casing having a light-exiting portion disposed adjacent to the outer periphery of the planar lightguide to exit light that is emitted from the planar lightguide to an outside of the casing.

15. The electronic device of claim 14, wherein the electronic device is a mobile phone, and the light-emitting diode light sources of the light-emitting unit are driven according to a condition of a communication function of the mobile phone.

16. The light-emitting unit of claim 8, wherein respective optical axes of the first pair of light-emitting diode light sources obliquely intersect each other, and respective optical axes of the second pair of light-emitting diode light sources obliquely intersect each other.

17. A light-emitting unit comprising: a planar lightguide having a light-transmitting portion, a reflecting portion provided in the planar lightguide, and a light-exiting portion provided on an outer periphery of the planar lightguide,
the light-transmitting portion of the planar lightguide that transmits light emitted from the light-emitting diode light sources,
the reflecting portion comprising an opening that has an elongated shape in the planar lightguide, the reflecting portion receiving light emitted from the light-emitting diode light sources and reflecting light toward the outer periphery of the planar lightguide,
the light-exiting portion on the outer periphery of the planar lightguide to emit light that is transmitted through the light-guide portion to an outside of the planar lightguide;
a plurality of light-emitting diode light sources having light-emitting surfaces that obliquely face elongated sides of the reflecting portion emit light into the planar lightguide; and
the light-transmitting portion of the planar lightguide further having holes each accommodating each of the light-emitting diode light sources.

18. The light-emitting unit of claim 12, wherein the microscopic optical configuration portion has a rectangular ring shape along the outer periphery of the planar lightguide.

19. The light-emitting unit of claim 1, wherein the light-transmitting portion further includes a plurality of holes each accommodating each of the light-emitting diode light sources.
